(19) United States
(12) Patent Application Publication
(10) Pub. No.: US 2025/0115047 A1
(43) Pub. Date: Apr. 10, 2025

(54) LIQUID EJECTION HEAD, LIQUID EJECTION APPARATUS, AND MANUFACTURING METHOD OF LIQUID EJECTION HEAD

(71) Applicant: CANON KABUSHIKI KAISHA, Tokyo (JP)

(72) Inventors: SATOSHI KIMURA, Kanagawa (JP); HIROMASA AMMA, Kanagawa (JP); SHINGO OKUSHIMA, Kanagawa (JP); SHOGO KAWAMURA, Kanagawa (JP)

(21) Appl. No.: 18/888,475

(22) Filed: Sep. 18, 2024

(30) Foreign Application Priority Data
Oct. 5, 2023 (JP) 2023-173811

(51) Int. Cl. B41J 2/16; B41J 2/14

(52) U.S. Cl. CPC B41J 2/1606; B41J 2/14

(57) ABSTRACT

An object is to provide a liquid ejection head capable of suppressing corrosion. The liquid ejection head attachable to and detachable from a liquid ejection apparatus comprises a liquid ejection unit capable of ejecting liquid and a support member capable of supporting the liquid ejection unit. In the liquid, a predetermined component is includes. In the support member, metal is included. The surface of the support member is covered with an oxide cover layer having a thickness of 1 μm or more provided by predetermined treatment.

### BACKGROUND

### Field of the Disclosure

The present disclosure relates to a liquid ejection head, a liquid ejection apparatus, and a manufacturing method of a liquid ejection head.

### Description of the Related Art

Japanese Patent Laid-Open No. 2023-006649 has disclosed a liquid ejection head comprising a metal liquid ejection unit support portion and a liquid ejection unit supported by the liquid ejection unit support portion.

In a liquid ejection apparatus, it may happen sometimes that liquid floats without landing on a printing medium in a case where a liquid ejection unit ejects the liquid. Further, it may also happen that a volatile component, such as moisture and solvent, in a case where liquid having landed on a printing medium dries exists within a printing apparatus. With the liquid ejection head comprising a metal member as in Japanese Patent Laid-Open No. 2023-006649, there is a possibility that the metal member corrodes in a case where liquid sticks to the metal member.

### SUMMARY

Consequently, an object of the present disclosure is to provide a liquid ejection head capable of suppressing corrosion.

The liquid ejection head according to the present disclosure includes: a liquid ejection unit configured to eject liquid; and a support member configured to support the liquid ejection unit, wherein the support member includes metal and the surface of the support member is covered with an oxide cover layer having a thickness of 1 μm or more.

Further features of the present disclosure will become apparent from the following description of exemplary embodiments with reference to the attached drawings.

### BRIEF DESCRIPTION OF THE DRAWINGS

FIG. 1 a schematic perspective diagram of a liquid ejection apparatus in one embodiment;

FIG. 2 is a schematic diagram showing one example of a circulation path that can be applied to one embodiment;

FIG. 3A is a schematic perspective diagram of a liquid ejection head in one embodiment in a case of being viewed from the side of a negative pressure control unit;

FIG. 3B is a schematic perspective diagram of a liquid ejection head in one embodiment in a case of being viewed from the side of an element substrate;

FIG. 4 is an outer appearance perspective diagram of a liquid ejection head in one embodiment;

FIG. 5 is an enlarged diagram of a fixed portion of a first positioning member in one embodiment; and

FIG. 6 is an exploded diagram of a fixed portion of a protection member in one embodiment.

### DESCRIPTION OF THE EMBODIMENTS

### First Embodiment

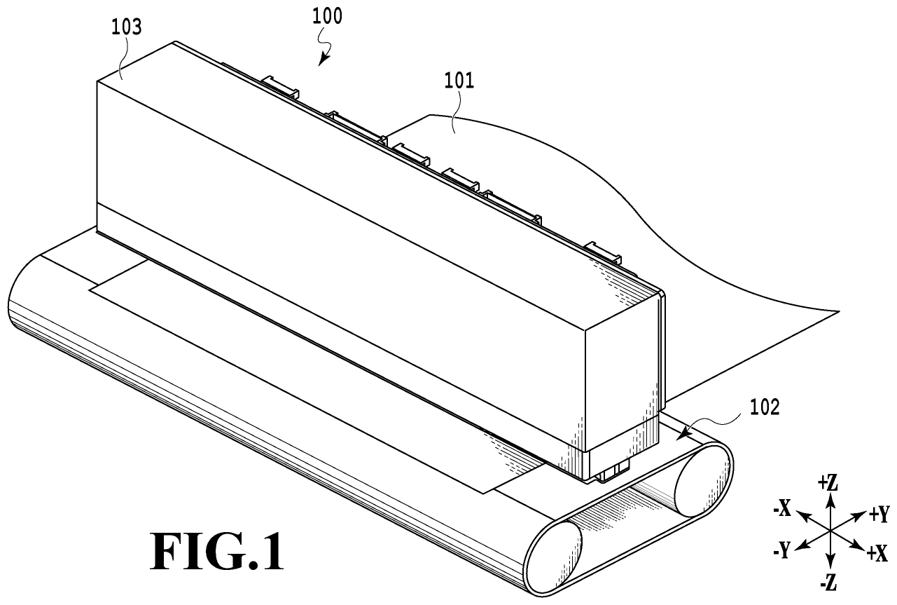

FIG. 1 is a schematic perspective diagram of a liquid ejection apparatus 100 in the present embodiment.

Coordinate axes in the drawings are explained. In the drawings referred to in the present specification, the X-direction and the Y-direction indicate two directions perpendicular to each other on a horizontal plane. The Z-direction indicates the vertical direction. The +Y-direction indicates the backward direction of a liquid ejection head 103, the −Y-direction indicates the forward direction, the +X-direction indicates the leftward direction in a case of being viewed in the frontward direction, the −X-direction indicates the rightward direction, the +Z-direction indicates the upward direction, and the −Z-direction indicates the downward direction, respectively. The −Y-direction also indicates the downstream side in the conveyance direction of a printing medium 101 and the +Y-direction also indicates the upstream side in the conveyance direction of the printing medium 101. The Y-direction is called the conveyance direction as appropriate. Further, the X-direction is the longitudinal direction (width direction) of the liquid ejection head 103, the Y-direction is the transverse direction (depth direction) of the liquid ejection head 103, and the Z-direction is the height direction of the liquid ejection head 103. In the following explanation. unless described particularly, the upward, downward, leftward, and rightward directions indicate directions in the posture in which the liquid ejection head 103 is used in the normal state.

In the present embodiment, explanation is given on the assumption that “liquid” is ink. However, the liquid that can be used in the present embodiment is not limited to ink. That is, as the liquid, it may also be possible to use various printing liquids including a processing liquid or the like that is used for the purpose of improving the fixing property of ink in a printing medium, reducing gloss unevenness, or improving scratch resistance.

“Printing” means not only forming significant information, such as a character and graphics. “Printing” also means forming meaningless information, such as an image or pattern. Further, “printing” is irrespective of whether or not visualization is performed so as to enable visual perception by a human being. That is, “printing” also means forming a structure for a printing medium or modifying a medium.

As shown in FIG. 1, in the present embodiment, explanation is given by supposing a case where the liquid ejection apparatus 100 is a line type (page-wide type) ink jet printing apparatus performing printing by ejecting ink. The liquid ejection apparatus 100 comprises a conveyance unit 102 configured to convey the printing medium 101 and the line type liquid ejection head 103 arranged substantially perpendicular to the conveyance direction (−Y-direction) of the printing medium 101. That is, the liquid ejection apparatus 100 is a line type printing apparatus capable of performing continuous printing by one pass while conveying a plurality of the printing media 101 continuously or intermittently.

The printing medium 101 is not limited to a cut sheet as long as it is possible to append liquid to the printing medium 101. As another example of the printing medium 101, there is continuous roll paper. In the present embodiment, it is possible for the liquid ejection head 103 to perform printing with ink of a single color (for example, black).

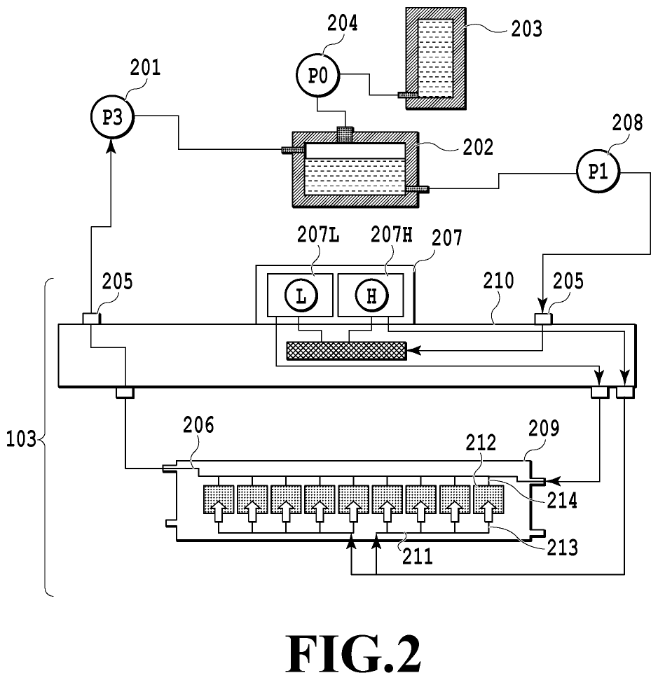

A liquid supply unit, which is a supply path through which liquid is supplied to the liquid ejection head, a main tank 203 (see FIG. 2), and a buffer tank 202 (see FIG. 2) are connected to the liquid ejection head 103 fluidly.

Further, to the liquid ejection head 103, an electrical control unit configured to transmit power and an ejection control signal to the liquid ejection head 103 is connected electrically. The liquid path and the electric signal path within the liquid ejection head 103 will be described later.

FIG. 2 is a schematic diagram showing one example of a circulation path that can be applied to the present embodiment.

As shown in FIG. 2, the liquid ejection head 103 is fluidly connected to a first circulation pump 201, the buffer tank 202 and the like. The buffer tank 202 as a sub tank, which is connected with the main tank 203, has an atmosphere communication opening (not shown schematically) causing the tank inside and the outside to communicate with each other and is capable of discharging air bubbles in ink to the outside. The buffer tank 202 is also connected with a replenishing pump 204.

The replenishing pump 204 is capable of sending ink corresponding to the amount of ink consumed by the liquid ejection head 103 ejecting ink from the main tank 203 to the buffer tank 202. For example, the liquid ejection head 103 ejects and consumes ink in a case of performing printing, suction restoration and the like.

The first circulation pump 201 has a role to pull out liquid from a liquid connection section 205 of the liquid ejection head 103 and causes the liquid to flow to the buffer tank 202. In a case where the liquid ejection head 103 is driving, a predetermined amount of ink flows within a common collecting channel 206 by the first circulation pump 201.

A negative pressure control unit 207 is provided on a path between a second circulation pump 208 and a liquid ejection unit 209. The negative pressure control unit 207 has a function of operating so as to maintain the pressure on the downstream side (that is, the side of the liquid ejection unit 209) of the negative pressure control unit 207 at a predetermined pressure set in advance even in a case where the flow rate of the circulation system fluctuates due to the difference in the printing density with which printing is performed.

The negative pressure control unit 207 comprises a first pressure adjustment mechanism 207H and a second pressure adjustment mechanism 207L, each of which is set to a control pressure different from each other. The first pressure adjustment mechanism 207H is connected to a common supply channel 211 within the liquid ejection unit 209 via the inside of a liquid supply unit 210. The second pressure adjustment mechanism 207L is connected to the common collecting channel 206 within the liquid ejection unit 209 via the inside of the liquid supply unit 210. The liquid ejection unit 209 is provided with the common supply channel 211, the common collecting channel 206, and an individual supply channel 213 and an individual collecting channel 214 each communicating with each of a plurality of element substrates 212.

The individual supply channel 213 and the individual collecting channel 214 communicate with the common supply channel 211 and the common collecting channel 206. Because of this, part of liquid flowing through the first circulation pump 201 flows from the common supply channel 211 to the common collecting channel 206 through the internal channel of the element substrate 212 (see arrow in FIG. 2). The reason is that a pressure difference is provided between the first pressure adjustment mechanism 207H connected to the common supply channel 211 and the second pressure adjustment mechanism 207L connected to the common collecting channel 206 and the first circulation pump 201 is connected only to the common collecting channel 206.

In this manner, in the liquid ejection unit 209, a flow of liquid passing through the inside of the common collecting channel 206 and a flow passing through the inside of each element substrate 212 from the common supply channel 211 toward the common collecting channel 206 occur. Because of this, it is possible to discharge the heat generated in each element substrate 212 to the outside of the element substrate 212 by the flow from the common supply channel 211 to the common collecting channel 206.

Further, with the configuration such as this, it is possible to cause a flow of ink to occur also in an ejection port or a pressure chamber, in which printing is not performed, in a case where printing by the liquid ejection head 103 is being performed, and therefore, it is possible to suppress ink in that portion from thickening.

Further, it is possible to discharge the ink having thickened and foreign matter in the ink to the common collecting channel 206. Because of this, it is made possible for the liquid ejection head 103 of the present embodiment to perform high-speed printing with high image quality.

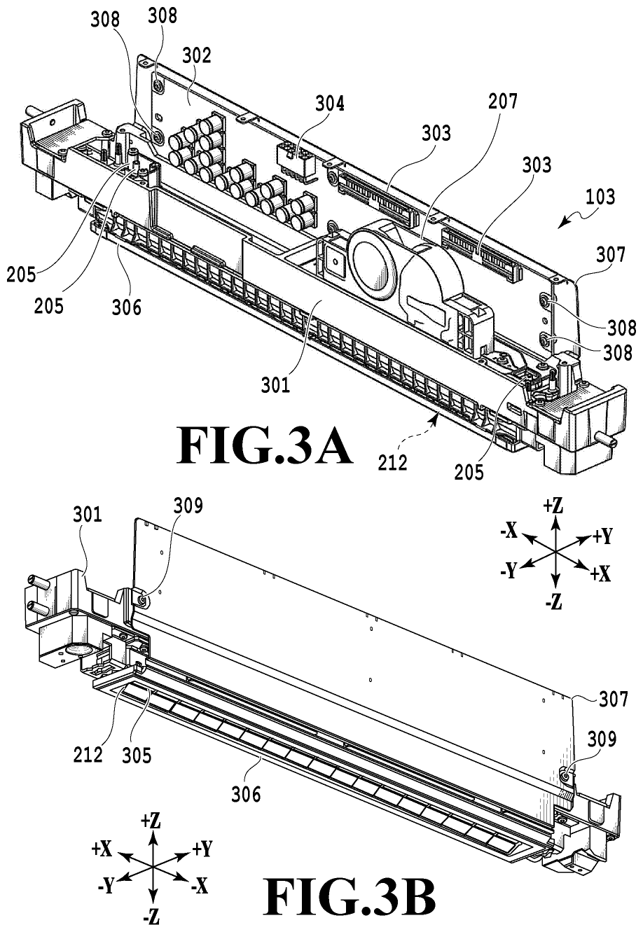

FIG. 3A is a schematic perspective diagram in a case where the liquid ejection head 103 in the present embodiment is viewed from the side of the negative pressure control unit 207. FIG. 3B is a schematic perspective diagram in a case where the liquid ejection head 103 in the present embodiment is viewed from the side of the element substrate 212.

As shown in FIG. 3A, on one side of the liquid ejection head 103, the liquid connection section 205 that can be connected to a liquid supply system of the liquid ejection apparatus 100 is provided. From the liquid supply system, ink is supplied to the liquid ejection head 103 via the liquid connection section 205. Then, the ink having passed through the inside of the liquid ejection head 103 is collected to the liquid supply system via the liquid connection section 205. As described above, in the present embodiment, it is possible to circulate ink via the path of the liquid ejection apparatus 100 and the path of the liquid ejection head 103.

Further, the liquid ejection head 103 comprises a support member 301 configured to support the negative pressure control unit 207. To the support member 301, an electrical wiring substrate 302 is attached. The electrical wiring substrate 302 is provided with a signal input terminal 303 and a power supply terminal 304, both being electrically connected with a control unit (for example, CPU not shown schematically) of the liquid ejection apparatus 100.

It is possible for the signal input terminal 303 to receive an ejection drive signal for ejecting liquid, which is transmitted from the control unit, and to transmit the ejection drive signal to the element substrate 212. It is possible for the power supply terminal 304 to receive power necessary for ejecting liquid, which is transmitted from the control unit, and to supply the power to the element substrate 212.

By aggregating wiring lines by an electrical circuit within the electrical wiring substrate 302, it is possible to reduce the number of signal input terminals 303 and the number of power supply terminals 304 compared to the number of element substrates 212. Due to this, the number of electrical connection sections may be small, which need to be removed in a case where the liquid ejection head 103 is assembled to the liquid ejection apparatus 100 or in a case where the liquid ejection head 103 is exchanged with another.

As shown in FIG. 3B, in the present embodiment, the line type liquid ejection head 103 is used, in which a plurality of the element substrates 212 is arrayed on a straight line (arranged in-line). It is possible for each of the plurality of the element substrates 212 to eject ink.

The element substrate 212 has a plurality of energy generation elements (for example, heating elements such as heaters) generating energy for ejecting liquid. Each of the plurality of energy generation elements is provided at the position corresponding to each of a plurality of ejection ports. By the energy generation element driving, liquid droplets are ejected from the ejection port.

To the element substrate 212, the end portion of a flexible wiring substrate 305 is connected. The other end portion of the flexible wiring substrate 305 is connected to the electrical wiring substrate 302 (see FIG. 3A). The element substrate 212 and the signal input terminal 303 (see FIG. 3A) are connected electrically via the flexible wiring substrate 305 and the electrical wiring substrate 302. Then, the element substrate 212 and the power supply terminal 304 are connected electrically via the flexible wiring substrate 305 and the electrical wiring substrate 302.

The flexible wiring substrate 305 and the electrical wiring substrate 302 are connected electrically at a contact face (reverse side of the face on which the signal input terminal 303 and the power supply terminal 304 are provided) of the electrical wiring substrate 302.

Around the element substrate 212, a cover member 306 configured to cover the element substrate 212 and the flexible wiring substrate 305 is comprised.

Further, the electrical wiring substrate 302 is protected from the outside by a protection member 307. The protection member 307 has a role of an electrical shield. Because of this, it is preferable for the protection member 307 to be configured by metal. In the present embodiment, the protection member 307 is configured by stainless. The electrical wiring substrate 302 is fixed to the protection member 307 with first stainless screws 308. The protection member 307 is fixed to the support member 301 with second stainless screws 309.

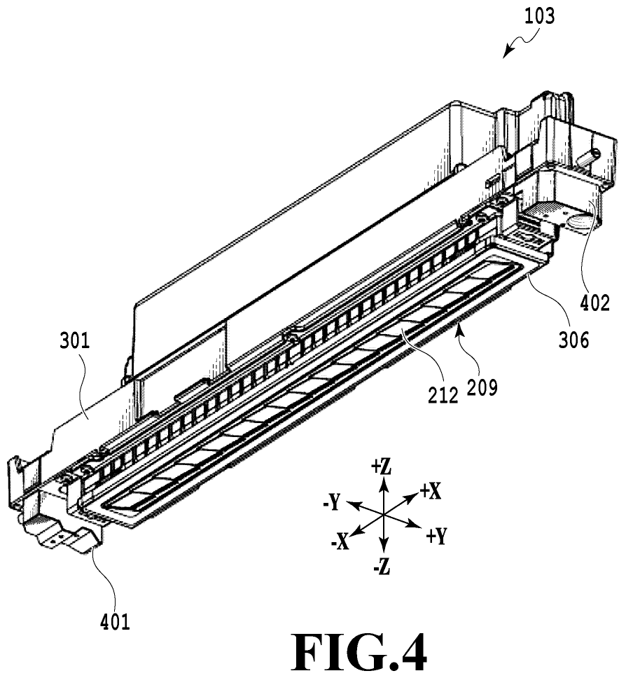

FIG. 4 is an outer appearance perspective diagram of the liquid ejection head 103 in the present embodiment.

As shown in FIG. 4, to the support member 301, the liquid ejection unit 209 including the element substrate 212 is attached. Further, to the support member 301, a first positioning member 401 and a second positioning member 402 for determining a position in a case where the liquid ejection head 103 is mounted on the liquid ejection apparatus 100 (see FIG. 1). It is preferable for the first positioning member 401 and the second positioning member 402 to be configured by metal material. The reason is to secure rigidity for positioning in a case where the liquid ejection head 103 is mounted on the liquid ejection apparatus 100.

Further, it is necessary for the support member 301 to have a shape to which the liquid ejection unit 209, the first positioning member 401, the second positioning member 402 and the like can be attached. As one example of the material of the support member 301, there are iron, stainless, copper, titanium, aluminum and the like, and in addition thereto, alloy of two or more kinds of these. In a case where the degree of freedom of shape, the mass productivity, and the cost of the support member 301 are taken into consideration, among the metal materials, aluminum alloy is appropriate.

In the present embodiment, the support member 301 is formed by the aluminum die casting method. Because of this, the manufacturing method of the support member 301 includes a process of forming the support member 301 by pouring molten metal into a die and a process of performing Alumite treatment for the support member 301 taken out of the die. By attaching the liquid ejection unit 209 to the support member 301 thus manufactured, the liquid ejection head 103 is manufactured.

At the time in point at which the support member 301 is taken out of the die by extruding it, there is a case where there remain a die trace having stuck in pouring molten metal, an extrusion trace having stuck in extruding the support member 301, and the like on the surface of the support member 301. It may also be possible to delete these trace by polishing the surface of the support member 301, and so on.

In the liquid ejection apparatus 100 (see FIG. 1), in a case where liquid is ejected, there is a possibility that part of the liquid floats within the apparatus and the floating liquid sticks to the support member 301. Depending on the moisture in a case where the liquid appended to the printing medium 101 dries and the liquid that is used, it may happen sometimes that the volatile component of the solvent or the like exists in the surrounding atmosphere. In a case where such liquid contains any one or more of chloride ions, hydrogen sulfide ions, and ammonia ions, particularly, in a case where such liquid contains chloride, hydrogen sulfide, ammonia and the like, the influence on the corrosion of metal is great.

As described above, the material of the support member 301 includes aluminum. Because of this, by the influence of chloride, hydrogen sulfide, ammonia and the like included in liquid, there is a possibility that the support member 301 corrodes. Consequently, surface treatment for corrosion resistance is performed for the support member 301.

In the present embodiment, Alumite treatment is performed for the support member 301. As the results of performing Alumite treatment, the surface of the support member 301 is covered with an oxide cover layer. In order to suppress corrosion effectively, it is preferable for the surface of the support member 301 to be covered with an oxide cover layer having a thickness of 1 μm or more. More preferably, the surface of the support member 301 is covered with an oxide cover layer having a thickness of 5 μm or more.

As the surface treatment of the support member 301, it is also considered to perform chromate treatment. However, the thickness of a cover layer by the chromate treatment is generally 1 μm or less. That is, the thickness of a cover layer by the chromate treatment is less than the thickness of an oxide cover layer by the Alumite treatment, and therefore, there is a tendency for the corrosion resistance by the chromate treatment to be inferior to the corrosion resistance by the Alumite treatment.

Further, the cover layer by the chromate treatment has electrical conductivity. Because of this, it is difficult to obtain the effect to suppress galvanic corrosion, to be described later, by the chromate treatment. Here, the galvanic corrosion is a phenomenon in which corrosion occurs by the intervention of moisture or the like in a state where metals of different kinds are in contact with each, not the corrosion due to the ingredient of liquid. There is a possibility that the galvanic corrosion occurs by moisture or the like acting as an electrolytic solution on the portion at which two different kinds of metals are in contact, for example, aluminum and iron, aluminum and stainless, and the like.

As described above, the protection member 307 is fixed to the support member 301 including aluminum with the second stainless screws 309. Further, to the support member 301, a member other than the protection member 307 is attached with stainless screws. Consequently, in the present embodiment, in order to suppress the galvanic corrosion, the two different kinds of metal members are insulated.

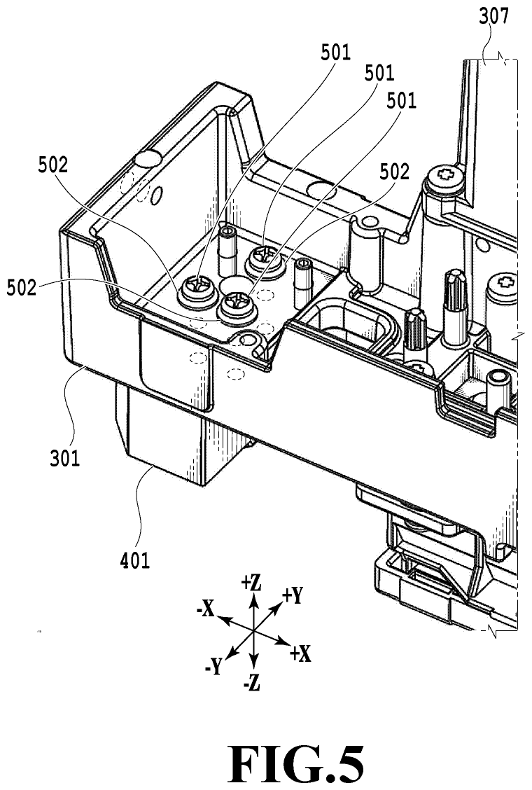

FIG. 5 is an enlarged diagram of a fixed portion of the first positioning member 401 in the present embodiment.

As shown in FIG. 5, the first positioning member 401 is fixed to the support member 301 with third stainless screws 501. Between the third stainless screw 501 and the support member 301 including aluminum, a first insulation member 502 configured by a nonmetal material is sandwiched.

In the present embodiment, as the first insulation member 502, a resin washer is used. As described above, by the resin washer being sandwiched between the third stainless screw 501 and the support member 301 including aluminum, these two kinds of metal are insulated. Consequently, in the present embodiment, the galvanic corrosion at the fixed portion of the first positioning member 401 is suppressed. As long as it is possible for the first insulation member 502 to insulate the third screw 501 from the support member 301, the first insulation member 502 is not limited to the resin washer. The first insulation member 502 may be a sheet or the like configured by another material, such as rubber.

Further, the second positioning member 402 (see FIG. 4) is also fixed to the support member 301 with the third stainless screw 501. At the fixed portion of the second positioning member 402 (see FIG. 4) also, the first insulation member 502 is sandwiched between the third screw 501 and the support member 301. Consequently, the galvanic corrosion at the fixed portion of the second positioning member 402 (see FIG. 4) is also suppressed.

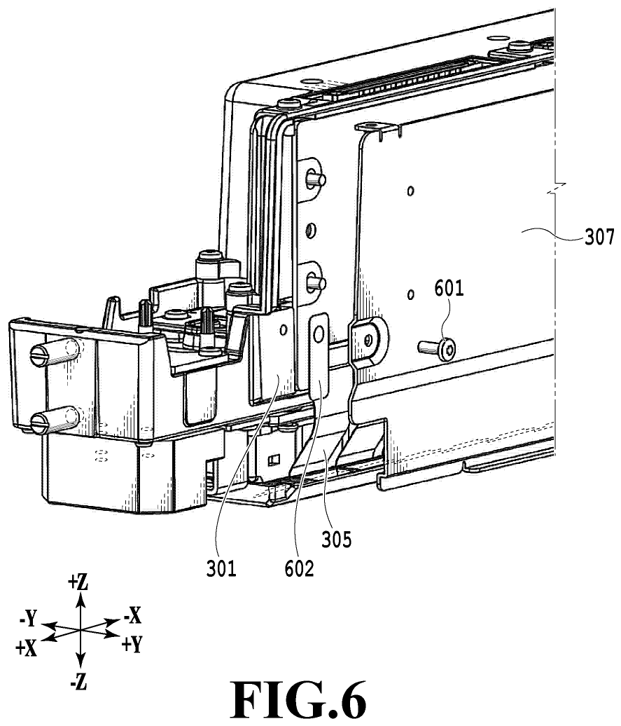

FIG. 6 is an exploded diagram of the fixed portion of the protection member 307 in the present embodiment.

As shown in FIG. 6, the protection member 307 is a stainless sheet metal member. The stainless protection member 307 is fixed to the support member 301 including aluminum with a fourth stainless screw 601. Between the support member 301 and the protection member 307, a second insulation member 602 configured by a nonmetal material is sandwiched.

The material of the second insulation member 602 is not limited as long as it is possible to insulate the stainless protection member 307 from the support member 301 including aluminum. As the material of the second insulation member 602, it is possible to use an insulator, for example, such as rubber, plastic, and paper.

As above, by the second insulation member 602 being sandwiched between the stainless protection member 307 and the support member 301 including aluminum, these two kinds of metal are insulated from each other. Consequently, in the present embodiment, the galvanic corrosion at the fixed portion of the protection member 307 is suppressed.

As explained above, the liquid ejection head 103 of the present embodiment comprises the support member 301 including aluminum. The Alumite treatment has been performed for the surface of the support member 301 and the surface of the support member 301 is covered with an oxide cover layer. Consequently, even in a case where ink sticks to the support member 301, ink does not come into contact with the portion including aluminum in the support member 301 due to the oxide cover layer.

Consequently, according to the liquid ejection head 103 of the present embodiment, it is possible to suppress corrosion.

Further, between the first stainless screw 501 and the support member 301 including aluminum, the first insulation member 502 is sandwiched. Consequently, it is also possible to suppress the galvanic corrosion at the fixed portion between the first positioning member 401 (see FIG. 4) and the second positioning member 402 (see FIG. 4).

Further, between the stainless protection member 307 and the support member 301 including aluminum, the second insulation member 602 is sandwiched. Consequently, it is also possible to suppress the galvanic corrosion at the fixed portion of the protection member 307.

### Other Embodiments

In the first embodiment, the liquid ejection apparatus comprises one liquid ejection head, but a plurality of liquid ejection heads may be mounted on the liquid ejection apparatus. For example, by the liquid ejection apparatus mounting four liquid ejection heads and each of the four liquid ejection heads ejecting inks of yellow, magenta, cyan, and black, it is made possible to perform full-color printing. In this case, it is not necessary to perform the Alumite treatment for the support members of all the liquid ejection heads. As long as the surface of the support member of the one or more liquid ejection heads among the four liquid ejection heads is covered with an oxide cover layer, it is possible to obtain the same effect as that of the first embodiment.

In the first embodiment, as one example, the thermal method is adopted, in which air bubbles are caused to occur by a heating element (heater) and liquid is ejected. However, it is also possible to apply the technique of the present disclosure to liquid ejection heads adopting the piezoelectric method and other various liquid ejection methods.

In the first embodiment, as the liquid ejection apparatus, the ink jet printing apparatus of an aspect is used, in which liquid such as ink is circulated between the tank and the liquid ejection head. However, another liquid ejection apparatus may be used, For example, a liquid ejection apparatus may be used, in which two tanks are provided on the upstream side and the downstream side of the liquid ejection head and ink within a pressure chamber is caused to flow by causing the ink to flow from one of the tanks to the other without circulating the ink.

According to the liquid ejection head of the present disclosure, it is possible to suppress corrosion.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-173811, filed Oct. 5, 2023 which are hereby incorporated by reference wherein in its entirety.

What is claimed is:

1. A liquid ejection head comprising:
a liquid ejection unit configured to eject liquid; and
a support member configured to support the liquid ejection unit, wherein
the support member includes metal and the surface of the support member is covered with an oxide cover layer having a thickness of 1 μm or more.

2. The liquid ejection head according to claim 1, wherein
the metal includes any one or more of iron, stainless, copper, titanium, and aluminum.

3. The liquid ejection head according to claim 1, further comprising:
a screw fixed to the support member, wherein
the screw includes metal different from metal included in the support member and
between the screw and the support member, an insulation member including a nonmetal material is sandwiched.

4. The liquid ejection head according to claim 1, further comprising:
a sheet metal member fixed to the support member, wherein
the sheet metal member includes metal different from metal included in the support member and
between the support member and the sheet metal member, an insulation member including a nonmetal material is sandwiched.

5. The liquid ejection head according to claim 1, wherein
the liquid ejection unit is configured to be capable of ejecting liquid containing any one or more of chloride ions, hydrogen sulfide ions, and ammonia ions.

6. The liquid ejection head according to claim 1, wherein
the liquid ejection unit has a plurality of element substrates arrayed so as to correspond to the width of a printing medium.

7. The liquid ejection head according to claim 1, wherein
the surface of the support member is covered with an oxide cover layer having a thickness of 5 μm or more.

8. The liquid ejection head according to claim 1, wherein
the support member is manufactured by an aluminum die casting method.

9. A liquid ejection apparatus comprising:
a liquid ejection head; and
a conveyance unit configured to convey a printing medium receiving liquid ejected from the liquid ejection head, wherein
the liquid ejection head includes:
a liquid ejection unit configured to eject liquid; and
a support member configured to support the liquid ejection unit, the support member includes metal, and
the surface of the support member is covered with an oxide cover layer having a thickness of 1 μm or more.

10. The liquid ejection apparatus according to claim 9, further comprising:
a second liquid ejection head ejecting liquid of a kind different from that of liquid of the liquid ejection head.

11. A manufacturing method of a liquid ejection head comprising a liquid ejection unit configured to eject liquid and a support member configured to support the liquid ejection unit, the manufacturing method comprising the steps of:
forming the support member by pouring molten metal into a die;
performing an alumite treatment for the support member; and
attaching the liquid ejection unit to the support member.

12. The manufacturing method of a liquid ejection head according to claim 11, wherein
the forming the support member includes an aluminum die casting method.
